(19) United States
(12) Patent Application Publication
(10) Pub. No.: US 2010/0141375 A1
(43) Pub. Date: Jun. 10, 2010

(54) Trace fuse with positive expulsion

(75) Inventor: Julius M. Liptak, Knightdale, NC (US)

Correspondence Address: SCHNEIDER ELECTRIC / SQUARE D COMPANY;LEGAL DEPT. - I.P. GROUP, 1415 S. ROSELLE ROAD, PALATINE, IL, 60067, US

(73) Assignee: Square D Company

(21) Appl. No.: 12/316,090

(22) Filed: Dec. 9, 2008

(51) Int. Cl. H01H 85/04

(52) U.S. Cl. 337/297; 337/290; 337/401

(57) ABSTRACT

A circuit interruption device for printed wiring boards having a positive expulsion device for removing melted fuse material, plasma and debris from the printed wiring board.

### CROSS-REFERENCE TO RELATED PATENTS

Not applicable

### STATEMENT REGARDING FEDERALLY SPONSORED RESEARCH OR DEVELOPMENT

Not applicable

### FIELD OF THE INVENTION

The present invention relates to over current protection devices and particularly to improved trace fuses on printed wiring boards.

### BACKGROUND OF THE INVENTION

The principle of using a fusible conductor or fuse in an electrical circuit for the purpose of providing protection to the circuit against overcurrent is well understood by those skilled in the art. The geometry of the fusible conductor, its composition, its suspension and connection into the circuit and the medium surrounding the fusible conductor all contribute to the ability of the fuse to open at the correct current level and successfully interrupt the current in the circuit.

When the fuse is subjected to an overcurrent, the fusible conductor begins to melt and increase impedance. The circuit voltage and inductance continue to force current through the molten portion of the fuse conductor until the material vaporizes and an arc begins. The arc continues until enough fusible conductor burns away to create a sufficient gap to block the circuit voltage and dissipate the inductive energy of the circuit. While the fusible conductor is burning, the medium surrounding the fusible conductor, typically a glass tube, fiber tube or silica filled containment area, plays an important role in absorbing the arc energy, containing the metal vapor from the conductor and creating an appropriate circuit gap that can support the voltage of the circuit.

The construction of a fuse is contingent on many parameters including the circuit voltage, current and power factor, the required rapidity of the current interruption and the environment into which the fuse is placed. Generally, a least-cost construction that meets the electrical and environmental parameters is employed. When electronic or electrical equipment employs a printed wiring board (PWB) for the electrical interconnection of the components and fuses are required to protect a circuit that traverses the PWB, several possible fuse constructions could be utilized. One implementation of a fuse is to integrate the fusible conductor into the foil geometry on the PWB. This is generally done by inserting a foil section into the current path that has a substantially reduced cross-section. When an overcurrent occurs, the reduced cross-section of foil will melt and open the circuit.

This implementation has several advantages including an easily controllable geometry of the fusible conductor, inherent connection ability to the circuit being protected and low-cost. This implementation also has the disadvantage that as the PWB foil melts and arcs, the surface of the PWB is in contact with the arc and decomposition of the PWB material can occur. If the foil fuse is on a horizontal surface of the PWB the molten material can pool on the surface after melting, if the foil fuse is on a vertical surface the molten material can initiate arcing to other parts of the protected circuit. In either case, intermittent current flow in the protected circuit is initiated. This intermittent current flow results in arcing and carbonizing of the PWB surface, which results in further arc tracking on the PWB surface. Since the majority of PWB laminates are manufactured using an epoxy resin filler, the byproducts of decomposition can burn, adding to the energy release and also become conductive, resulting in continued conduction of current. In addition, it is possible that even if there is minimal arcing, the vaporized metal from the fused foil conductor can condense on the PWB surface and maintain a degree of current conduction through the circuit. The possibility of damage to the laminate or condensed metal vapor creating a conduction path typically limit satisfactory operation of these fuses to relatively low voltages, low currents and high power factors.

Therefore, it is desirable to provide a means for ejecting the fusible metal (both molten and vaporized) as well as the arc plasma from the surface of the PWB, thereby minimizing or eliminating the damage to the PWB laminate and reducing the degree of metal vapor condensation on the PWB surface. It is desirable to direct the conducting plasma into means that aid in the rapid extinguishment of the current in the circuit.

### BRIEF DESCRIPTION OF THE DRAWINGS

The features of the invention will be more clearly understood from the following detailed description of the invention read together with the drawings in which:

FIG. 1 illustrates a first embodiment of a trace fuse with positive expulsion means in accordance with the present invention.

FIG. 2 illustrates a second embodiment of a trace fuse with positive expulsion means in accordance with the present invention.

FIG. 3 illustrates a third embodiment of a trace fuse with positive expulsion means in accordance with the present invention.

FIG. 4 illustrates a fourth embodiment of a trace fuse with positive expulsion means in accordance with the present invention.

FIG. 5 illustrates a cross-section of the trace fuse of FIG. 4 taken along line A-A.

FIG. 6 illustrates a sixth embodiment of a trace fuse with positive expulsion means in accordance with the present invention.

FIG. 7 illustrates a cross-section of the trace fuse of FIG. 6 taken along line A-A in a multi layer printed wire board.

FIG. 8 illustrates a seventh embodiment of a trace fuse with positive expulsion means in accordance with the present invention.

FIG. 9 illustrates a cross-section of the trace fuse of FIG. 8 taken along line A-A in a multi layer printed wire board.

FIG. 10 illustrates a seventh embodiment of a trace fuse with positive expulsion means in accordance with the present invention.

FIG. 11 illustrates a cross-section of the trace fuse of FIG. 10 taken along line A-A in a multi layer printed wire board.

FIG. 12 illustrate the trace fuse embodiment of FIG. 10 on a multi-layer printed wiring board.

FIG. 13 illustrate a graphic representation of the forces operating on the trace fuse of FIG. 10.

FIG. 14 illustrates an eighth embodiment of a trace fuse with positive expulsion means in accordance with the present invention.

FIG. 15 illustrates a cross-section of the trace fuse of FIG. 14 taken along line A-A in a multi layer printed wire board.

FIG. 16 illustrates a ninth embodiment of a trace fuse with positive expulsion means in accordance with the present invention.

FIG. 17 illustrates a component trace fuse with positive expulsion means in accordance with the present invention.

Before one embodiment of the invention is explained in detail, it is to be understood that the invention is not limited in its application to the details of construction described herein or as illustrated in the drawings. The invention is capable of other embodiments and of being practiced or being carried out in various other ways. Further, it is to be understood that the phraseology and terminology used herein is for the purpose of description and should not be regarded as limiting.

### DETAILED DESCRIPTION OF THE DRAWINGS

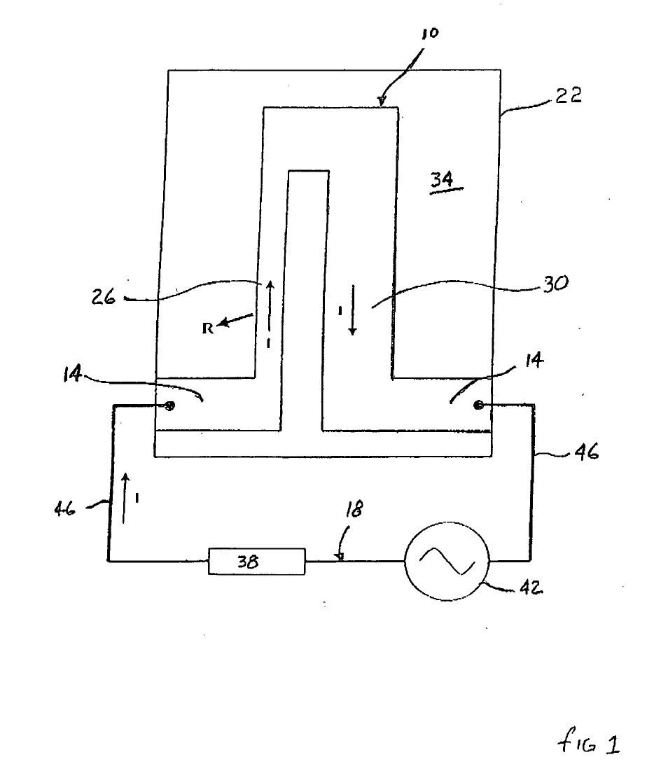

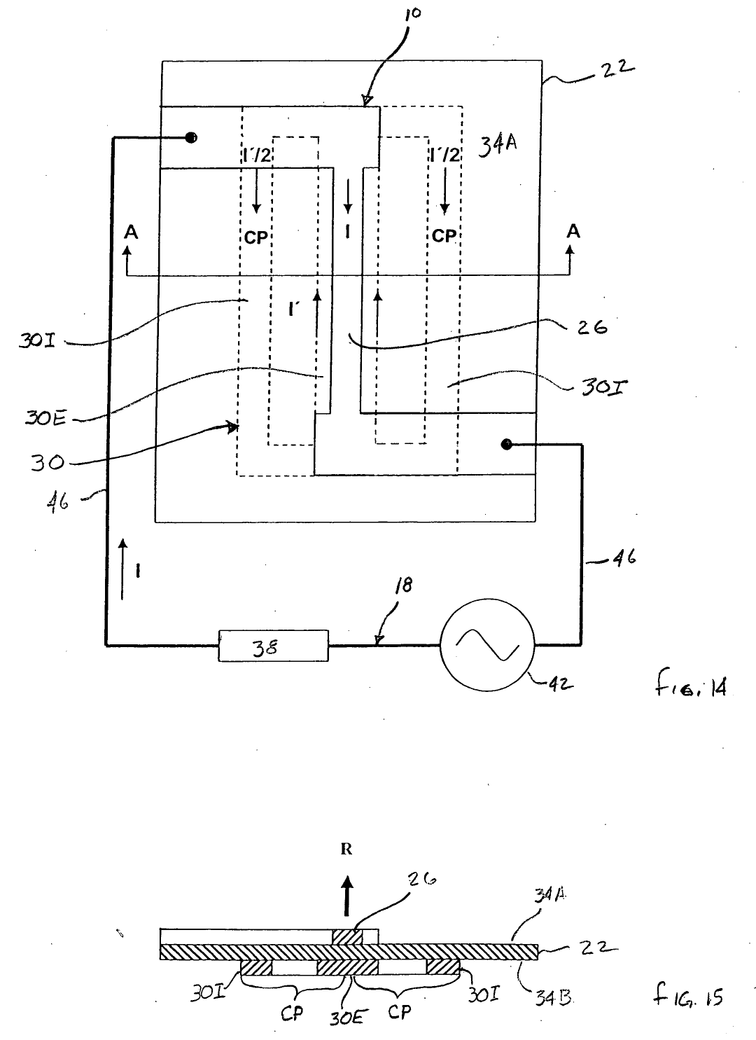

FIG. 1 illustrates a circuit interruption device such as a trace or foil fuse, constructed in accordance with the present invention and generally indicated by reference numeral 10. The following description of the foil fuse 10 covers the basic theory of operation employed in all of the embodiments shown in the figures and described herein. The foil fuse 10 can be an integral part of the trace or foil conductors 14 of a circuit 18 to be protected that is at least partially located on a printed wire board (PWB) 22 or any similar construction comprising alternating layers of rigid, semi-rigid or flexible conductors and dielectric materials as used in flexible wiring boards, flexible flat cable or multi-layer printed wiring boards as shown in FIG. 13. Since the circuits on a PWB can be complex and include a large number of electronic components only that small segment the PWB 22 supporting the foil fuse 10, which is the subject of this invention, is shown in the Figures. Other electronic components of the protected circuit 18 are indicated in the Figures by block 38 and power supply 42, which are shown electrically connected to the foil conductors 14 by wires 46. The foil fuse 10 has a first fuse element 26 and a second fuse element 30 arranged spatially in close proximity to each other and oriented such that current flowing in the first fuse element 26 is in a direction generally opposite to current flowing in the second fuse element 30. The arrows I indicate the direction of current flowing in the protected circuit 18 and the first and second fuse elements, 26 and 30 respectively. The cross-section, material composition and/or physical configuration of one of the first or second fuse elements, 26 or 30, is selected such that it will melt or liquefy at a predetermined thermal point, caused by an over current condition in the protected circuit 18, before the other of the first or second fuse elements, 26 or 30. Thus, one of the first or second fuse elements, 26 or 30, becomes a melting element that opens the protected circuit 18 when the predetermined thermal point has been exceeded. The spatial orientation and proximity of the first fuse element 26 with respect to the second fuse element 30 are selected such that the magnetic field surrounding the first or second fuse element, 26 or 30, that is not the melting element, acts upon the molten, vaporized and/or plasma portions of the melting element to expel them away from the surface 34 of the PWB 22 supporting or adjacent to the melting element. Thus, the other of the first or second fuse elements, 26 or 30, becomes an expulsion element removing the melted, vaporized or plasma portions of the melting element from the immediate area of the melting element. For simplicity, in the following descriptions of the various embodiments of this invention, the terms first fuse element and melting element will be interchangeable and associated with any variation of reference numeral 26 (e.g. 26A, 26B, etc.) and the terms second fuse element and expulsion element will be interchangeable and associated with any variation of reference numeral 30 (e.g. 30A, 30B, etc.).

In the configuration shown in FIG. 1, both of the first and second fuse elements, 26 and 30 respectively, are on the same surface 34 of the PWB 22 and electrically in series with each other and with the protected electrical circuit 18. The expulsion element 30 is arranged spatially with respect to the melting element 26 such that current flowing in the melting element 26 is generally opposite that flowing in the expulsion element 30, as shown by arrows I. They are also arranged spatially in significantly close proximity to one another such that the magnetic forces surrounding the expulsion element 30 are strong enough to expel the molten, vaporized and/or plasma material of the melting element 26 away from the PWB surface 34. The general direction of the expelled material of the melting element 26 is indicated by arrow R. By expelling the molten material away from the vicinity of the melting element 26 the protected circuit 18 is positively opened and the possibility of intermittent current flow and arcing in the protected circuit 18 is significantly reduced.

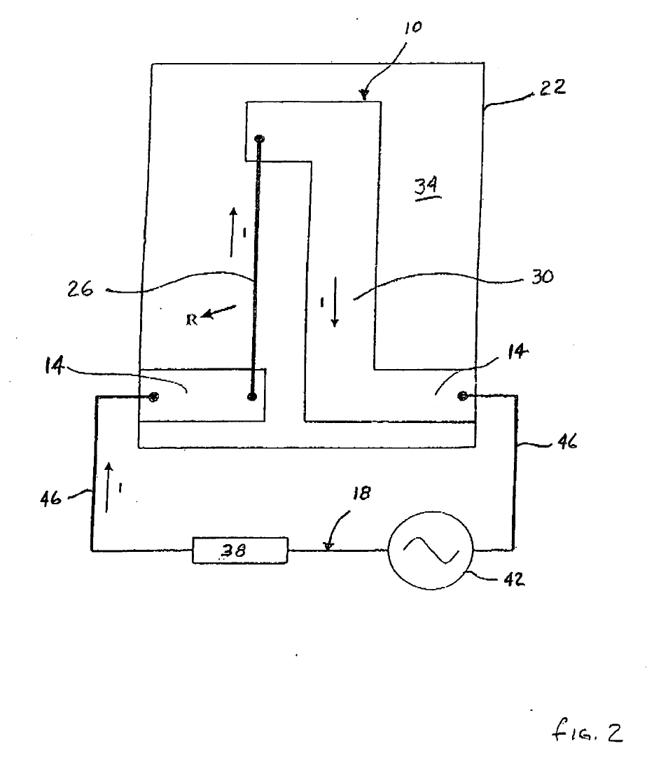

In the configuration shown in FIG. 2 the melting element 26 is replaced by a wire soldered between two points in the foil conductor 14. It is to be understood that a wire or other conducting element can be used in place of one or both of the melting element 26 or expulsion element 30 as long as the material composition and/or physical configuration, spatial arrangement and proximity of the two elements are such that expulsion of the molten material of the melting element 26 can be accomplished.

In the configuration of FIG. 3, the melting element 26 is spatially arranged generally between two expulsion elements 30A and 30B. All are located on the same surface 34 of the PWB 22. In this configuration the combined magnetic forces of the expulsions elements 30A and 30B expel the molten melting element 26 away from the PWB 22 in a direction generally along their longitudinal axes as indicated by arrow R. In FIG. 3 the expulsion elements 30A and 30B are shown generally perpendicular to the melting element 26, but it is to be understood that other angular configurations can produce the same effect.

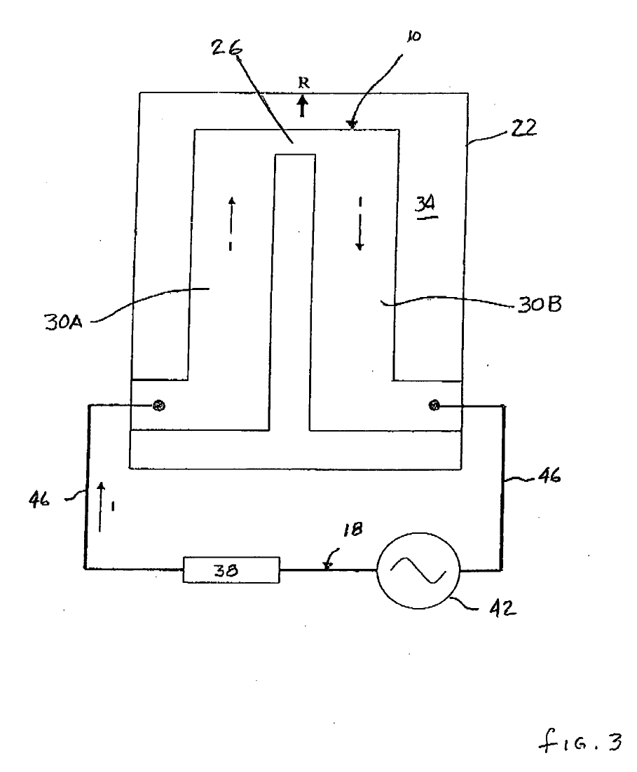

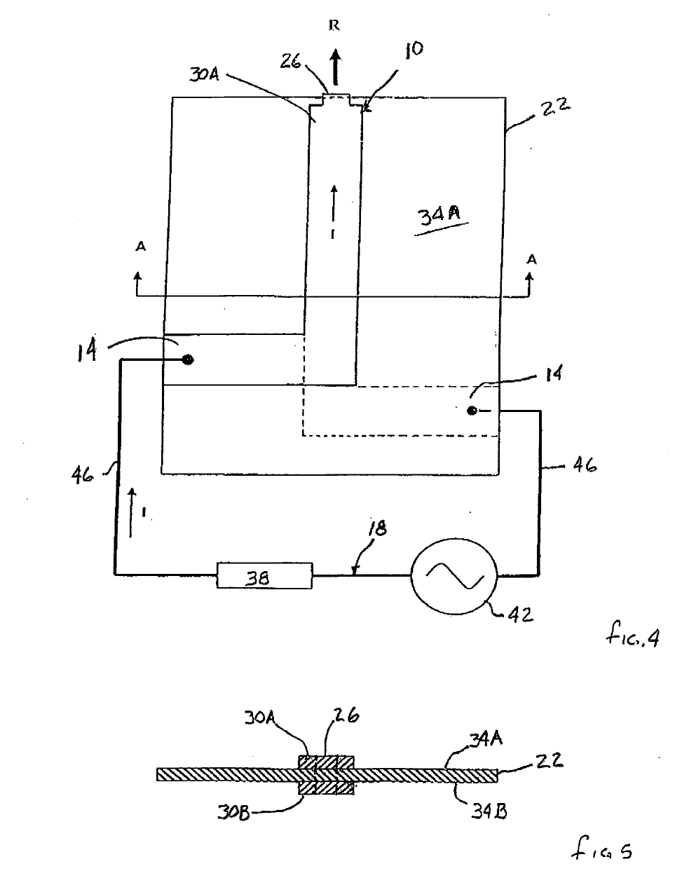

The configuration of FIG. 4, also illustrates the melting element 26 positioned generally between two expulsion elements 30A and 30B. However, in this configuration the melting element 26 folds over an edge 50 of the PWB 22 and the two expulsion elements 30A and 30B are located on opposite surfaces 34A and 34B of the PWB 22. FIG. 5 is a cross section taken along line A-A of FIG. 4 showing the orientation of the melting element 26 and expulsion elements 30A and 30B with respect to the surfaces 34A and 34B and edge 50 of PWB 22. The expulsion of the molten material of melting element 26 is away from the edge 50 of the PWB 22 as indicated by arrow R.

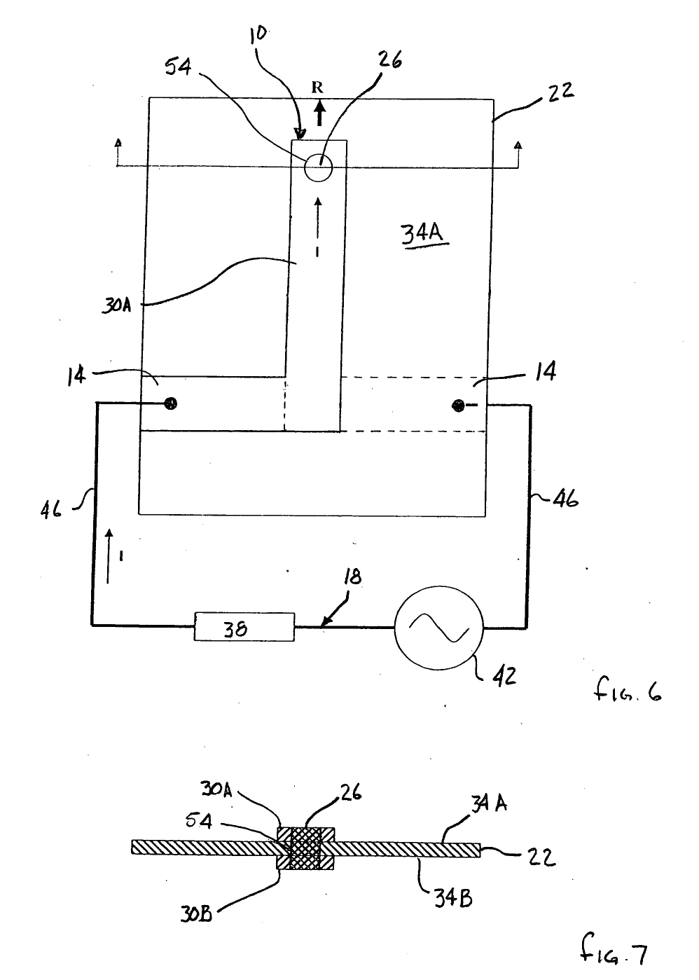

The configuration of FIG. 6 illustrates the melting element 26 as solder material electrically connecting two expulsion elements 30A and 30B together. The melting element 26 can also be formed by plating the inner surface of the passage 54 using standard PWB fabrication methods or the melting element 26 can be a combination of both the solder material and plating. The melting element 26 is generally confined in a passage 54 passing through the PWB 22 and electrically connecting the expulsion element 30A on surface 34A with the expulsion element 30B on surface 34B. FIG. 7 illustrates a cross-sectional view taken along line A-A of FIG. 6 showing the connection of expulsion elements 30A and 30B. The expulsion of the molten material of the melting element 26 is expelled in the general direction shown by arrow R.

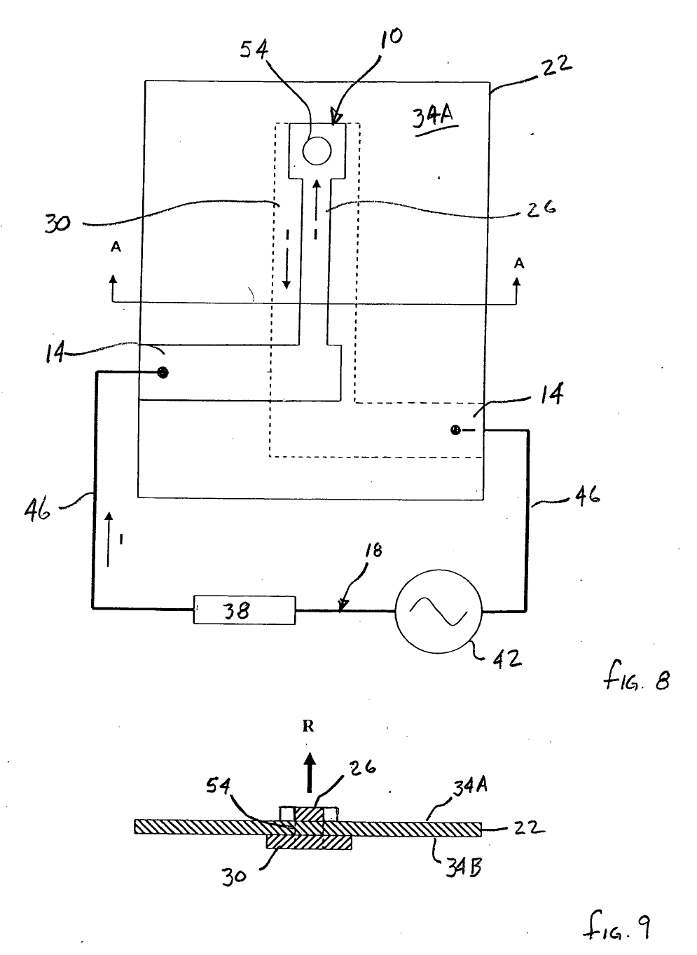

In the configuration of FIG. 8 the melting element 26 and expulsion element 30 are in generally parallel spatial arrangement on opposite surfaces 34A and 34B of the PWB 22 and electrically connect by solder through the passage 54 in the PWB 22, as in FIG. 6. The melting element 26 is generally I-shape in that it has a reduced cross-section between its two ends. The melting element 26 and expulsion element 30 are electrically in series such that current flowing in the melting element 26 is opposite that flowing in the expulsion element 30. FIG. 9 is a cross-section taken along line A-A of FIG. 8 showing the relation of melting element 26 and expulsion element 30 and indicating the general direction of expulsion of the molten portion of melting element 26 by arrow R.

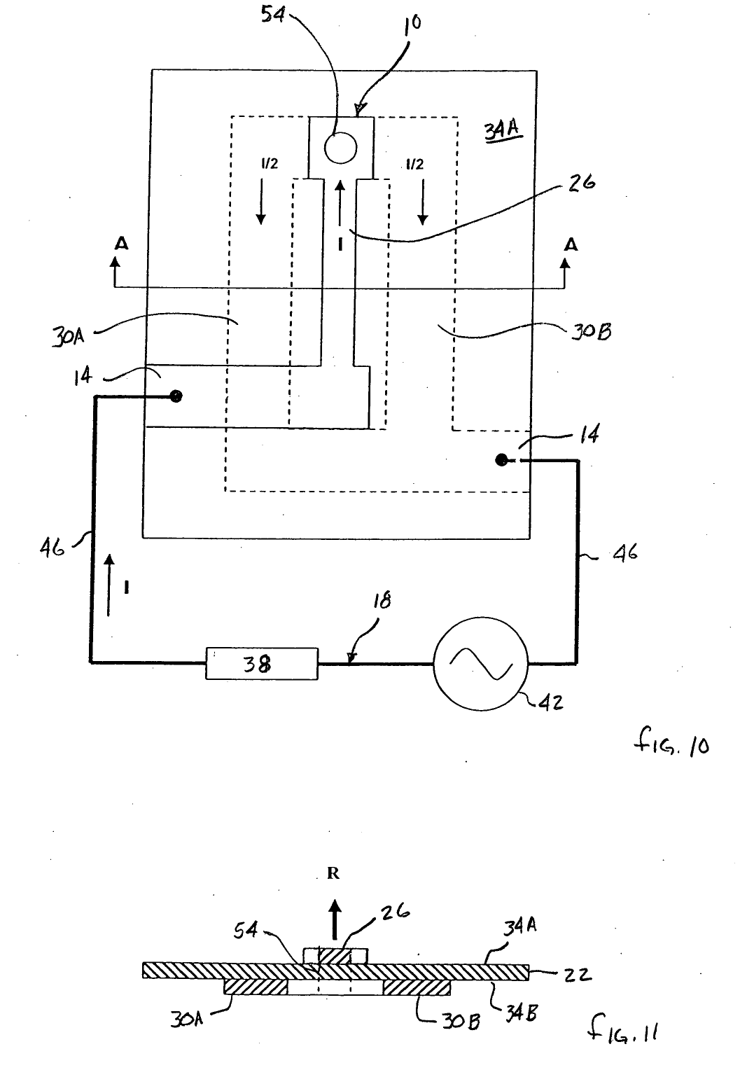

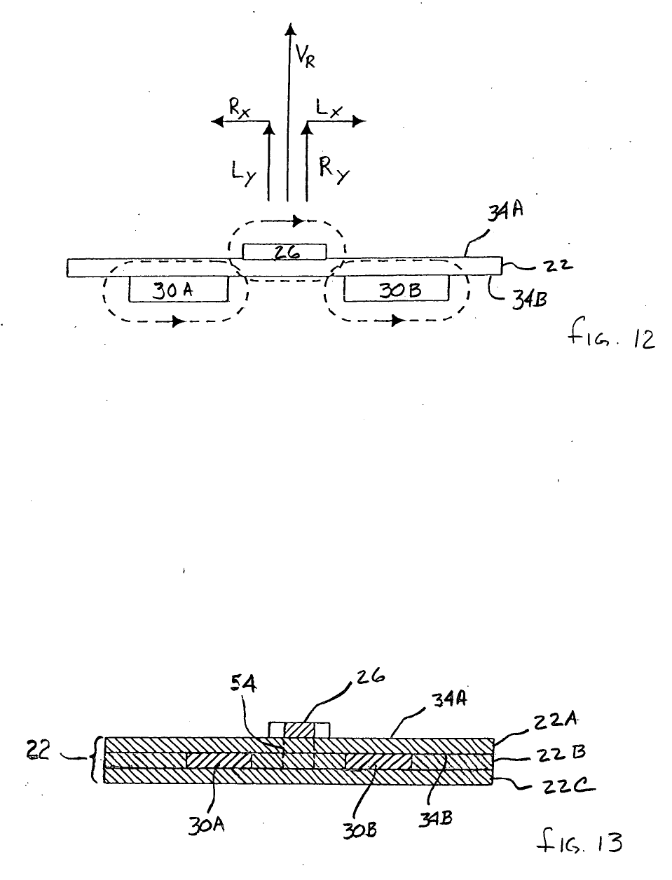

In the configuration of FIG. 10 the melting element 26 and expulsion elements 30A and 30B are in generally parallel spatial arrangement on opposite surfaces 34A and 34B of the PWB 22 and electrically connect by solder through the passage 54 in the PWB 22, as in FIG. 8. The melting element 26 and expulsion elements 30A and 30B are electrically in series such that current flowing in the melting element 26 is opposite that flowing in the expulsion elements 30A and 30B. The melting element 26 is show having the same reduced cross-section as shown in FIG. 8, but it is understood that other configurations previously shown in the Figures can be used. The expulsion elements 30A and 30B are electrically in parallel with one another such that ½ the current flows in each as indicated by the arrows I/2. FIG. 11 is a cross-section taken along line A-A of FIG. 10 showing the spatial relationship of the melting element 26 with respect to the expulsion elements 30A and 30B and indicating the general direction of expulsion of the molten portion of melting element 26 by arrow R.

FIG. 12 is a graphical illustration of the magnetic forces exerted on the melting element 26 by the expulsion elements 30A and 30B with respect to the current flow shown in FIG. 10 at the point of the cross-section of FIG. 11. For the interaction of any two conductors, the forces are proportional to the vector product of the currents flowing in the two conductors and inversely proportional to the spacing between the two conductors. The vectors Lₓ and L_{y} represent the X and Y forces of the expulsion element path 30A, shown on the left, and the vectors Rₓ and R_{y} represent the X and Y forces of the expulsion element path 30B, shown on the right. The vector V_{R} represents the resulting magnetic force applied to the melting element 26. These forces will occur any time the current flows regardless of whether the electrical conductors are solid, liquid or vapor. Therefore, a particular spatial placement of the expulsion elements 30A and 30B with respect to the melting element 26 can change the resulting force V_{R} such that the direction of expulsion of the melted or vaporized melting element 26 can be selected. In FIG. 12, it can be seen that both left and right expulsion elements 30A and 30B apply a vertical force, L_{Y} and R_{Y} respectively, and a horizontal force, L_{X} and R_{X} respectively, to the melting element 26. The resulting magnetic force V_{R} tries to push the melting element 26 away from the PWB 22. When the melting element 26 melts during an overcurrent event, these magnetic forces cause the molten and any vaporized material as well as any plasma to be pushed away from the surface 34A of the PWB 22 in a direction determined by the expulsion element 30A or 30B having the greatest magnetic field influence with respect to the melting element 26. In FIG. 12 the expulsion elements 30A and 30B are spatially positioned approximately equidistant from the melting element 26 and are sized such that each carries approximately half of the current flow (I′/2). Therefore, the resulting magnetic force V_{R} is generally perpendicular to the surface 34A of the PWB 22. However, if the expulsion elements 30A or 30B were spatially positioned such that one was closer to the melting element 26 than the other or if one expulsion elements 30A or 30B was sized to carry more current than the other expulsion element 30A or 30B, the resulting magnetic force V_{R} would be directed generally away from the strongest magnetic field opposing the melting element 26.

FIG. 13 illustrates the foil fuse configuration of FIG. 10 with a multiple layer PWB 22. In this configuration melting element 26 would remain on or adjacent the first exterior surface 34A of a first layer 22A of the PWB 22. The expulsion element 30 would remain on the second surface 34B, which is now an interior surface of the multi layer PWB 22. A second layer 22B of the PWB 22 would surround the expulsion element 30 and a third layer 22C of the PWB 22 could cover the expulsion element 30.

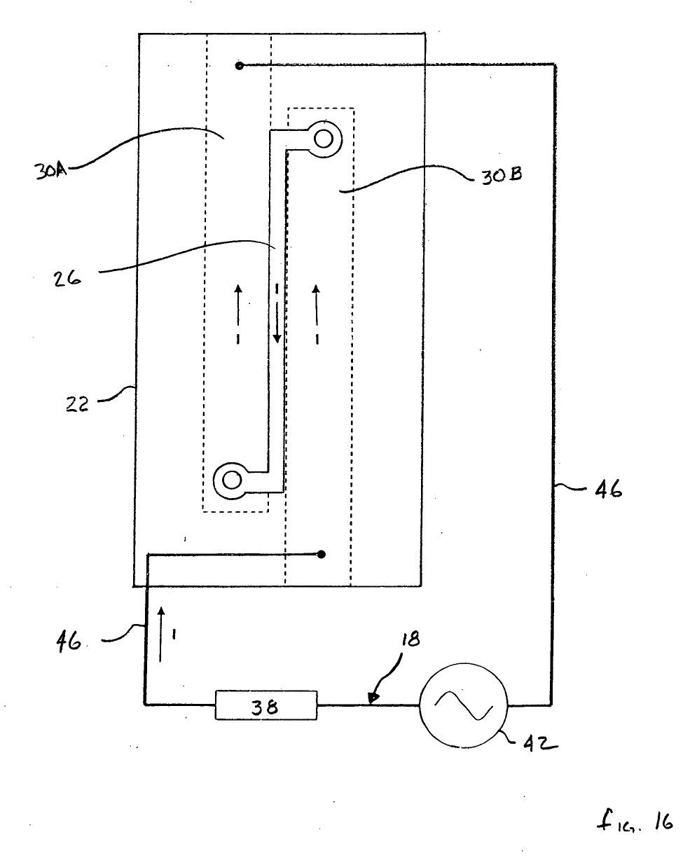

In the configuration of FIG. 14 the melting element 26 and expulsion element 30 are in generally parallel spatial arrangement on opposite sides 34A and 34B of the PWB 22. In this configuration the magnetic field intensity in the expulsion element 30 does not vary instantaneously with the current in the protected circuit 18. The melting element 26 is shown in the generally I-shaped configuration of FIG. 8, lies on or adjacent to the first surface 34A of PWB 22 and is electrically in series with the protected circuit 18. The intensity of a magnetic field developed around the melting element 26 is proportional to the current I flowing in the protected circuit 18. The expulsion element 30 lies on or adjacent to the second surface 34B of the PWB 22 and is comprised of one or more closed paths CP in which a voltage proportional to the change in magnetic field intensity surrounding the melting element 26 is induced. The induced voltage causes a current I′ to flow in the closed path CP. Each closed path CP has at least one attraction conductor 30I and an expulsion conductor 30E, arranged in parallel with one another and both being spatially arranged in parallel with the melting element 26. The current I′ flowing in the expulsion conductor 30E opposes the current I flowing in the melting element 26 and the current I′ flowing in the at least one attraction conductor 30I attracts the melting element 26. Therefore, the expulsion conductor 30E is spatially in closer proximity to the melting element 26 than the at least one attraction conductor 30I. The force contribution from at least one attraction conductor 30I can be minimized by the appropriate application of spacing between the at least one attraction conductor 30I and the melting element 26. In addition to the possibility of multiple closed paths CP, each closed path CP has impedance to the flow of current either due to the intrinsic shape, geometry and material of the conductors or by the addition of discrete circuit components (for example resistors, inductors, capacitors, transformers, etc., not shown) to the closed path CP. The addition of these circuit impedance elements can be used to alter the magnitude of the opposing current I′ flowing in the at least one expulsion conductor 30E with respect to the current flowing in the melting element 26. The impedances present in multiple closed paths CP may all be the same values or may be different so as to achieve certain desirable effects. Additionally, the indirect use of the protected circuit current I in the expulsion element 30 does not preclude the simultaneous use of the circuit current directly for the purposes of generating repulsive and attractive forces in the expulsion element 30.

The embodiment shown in FIG. 14 consists of two closed paths CP, each having one attraction conductor 30I and sharing the common expulsion conductor 30E. An alternate construction could consist of several closed paths having their expulsion conductors 30E arranged in a configuration for the desired effect on the melting element 26. In the embodiment of FIG. 14, the two attraction conductors 30I are sized to carry half of the induced current I′/2 and the common expulsion conductor 30E is sized to carry all of the induced current I′. The expulsion conductor 30E can be positioned such that the melted fuse element 26 and any arc plasma or other debris resulting from the overcurrent condition will be expelled in a desired direction away from the PWB 22.

In this configuration, the closed path CP formed on either side of the expulsion conductor 30E is dimensioned so that the closed path has a significant amount of self-inductance with respect to the resistance of the closed path CP. When a voltage is induced in the attraction conductors 30I by the change in the mutually coupled magnetic field intensity surrounding the melting element 26 and expulsion conductor 30E, the current builds in the closed paths CP. As the current I′ builds, energy is stored in that portion of the magnetic field associated with the self-inductance of the closed path CP. If no further voltage is produced due to the mutual magnetic field coupling of the melting element 26 and expulsion element 30, the current in the closed paths CP will continue to flow until the energy stored in the self-inductance is dissipated by the resistance of the closed paths CP.

This continuation of current I′ flow in the expulsion conductor 30E due to stored magnetic energy can be used to advantage. When the melting element 26 begins to melt, the additional impedance in series with the protected circuit 18 causes a decrease in the current I in the protected circuit 18. If the circuit current I was directly employed for the ejection of the molten and vaporized material as is shown in FIG. 14, the decrease in current I′ would occur in both the expulsion element 30 and the melting element 26. The loss of expulsive force due to the decrease in both currents I and I′ can significantly affect the ability of the expulsion element 30 to eject melting element 26 material off the PWB 22. However, in the case of FIG. 14, the presence of a current I′ in the expulsion conductor 30E resulting from the stored energy in the closed path CP self-inductance will maintain the magnetic field intensity around expulsion conductor 30E thereby minimizing the decrease in available expulsion force for the vaporized melting element 26 as the current I in the protected circuit 18 begins to decrease.

FIG. 15 is a cross-section taken along line A-A of FIG. 14. In this Figure the spatial orientation of the closed paths CP, attraction conductors 30I and expulsion conductor 30E with respect to the melting element 26 is illustrated.

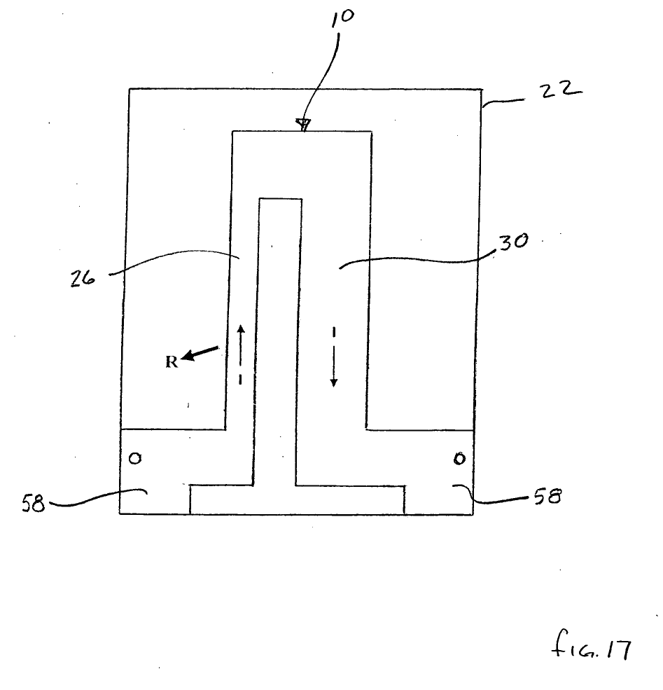

The configuration shown in FIG. 16, is similar to that of FIG. 10 in that the melting element 26 and two expulsion elements 30 are on opposite surfaces of the PWB 22. However, in this configuration the spatial arrangement and electrical connection of the melting element 26 and expulsion elements 30 is such that both of the expulsion elements 30 pass the full current I of the protected circuit 18. This in turn increases the cumulative expulsion force of the magnetic fields surrounding the expulsion elements 30 on the melting element 26.

FIG. 17 illustrates a replaceable foil fuse 10. The replaceable foil fuse 10 can employ any of the spatial and/or electrical configurations shown in FIGS. 1-16. The foil fuse 10 is placed on a small segment of PWB 22 and includes terminal pads 58 which make the electrical connection with protected circuit 18. The pads 58 can be configured to be received in typical clamping terminals such as would be used to accept cartridge type replaceable fuses or blade type replaceable fuses (not shown) or can be directly soldered to wires 46 of the protected circuit 18.

The fuse element embodiments shown in the illustration and described herein do not preclude the possibilities of other geometries or arrangements that use the principles of magnetic repulsion and attraction to achieve the desired objectives. Additionally, materials, geometries and constructions of fuse conductors that are well known to those skilled in the art can be employed in conjunction with this invention to achieve increased ratings of the fuse structure (i.e. higher voltage, faster current interruption, etc.). Such techniques include but are not limited to selections of metals for the fuse element to achieve the desired melting characteristics, the addition of multiple necks or vias in the fuse conductor to cause the formation of multiple series arcs for the purpose of increasing the counter voltage produced by the arc path to hasten current extinction and the addition of certain metals at midpoint of the fuse conductor to achieve a lower melting temperature during overcurrent (addition of m-spot).

Additionally, once the arc is ejected from the surface of the substrate, additional arc control techniques may be employed to manage and extinguish the arc in an expeditious fashion. These methods are well known to those skilled in the art and include, but are not limited to the following possibilities.
a) The fuse conductor can be immersed in specific gases, liquids or granular solids (for example electrical grade sand) known to hasten arc quenching and extinction while enhancing debris removal and management.
b) The arc can be directed into a quenching chamber or onto an ablative plate or mesh to cool and quench the arc thereby hastening extinction.
c) The arc can be directed into an arc splitter chamber whose end plates are connected in parallel with the ends of the fuse conductor and whose intermediate plates act to subdivide the directed arc column into intermediate arcs. When properly designed and dimensioned, the ejected arc will transfer to the end plates of the splitter chamber and be forced into the splitter plates. The subdivision extends the arc and creates multiple cathodes and anodes thereby increasing the circuit voltage required to drive the arc and dissipating circuit stored energy. Contact with the arc plates removes heat from the arc thereby quenching the arc. Additionally, by controlling the path of the current that flows into the end plates, additional repulsive forces can be generated to further propel the arc in the desired direction with the ultimate objective being dissipation of the arc plasma and reconstitution of the dielectric strength of the insulating medium in which the plasma formed.

I claim:

1. An improved circuit interruption device for printed wiring boards or similar constructions comprising alternating layers of electrical conductors and dielectric material, the interruption device comprising:
at least one melting element, and;
at least one expulsion element, being arranged spatially such that the at least one melting element and at least one expulsion element lie on or are immediately adjacent a surface of the printed wiring board or similar construction and are arranged spatially with respect to one another such that current flowing in the least one melting element is generally opposed to current flowing in the at least one expulsion element.

2. The interruption device of claim 1, wherein the at least one expulsion element is spatially arranged sufficiently close to the melting element to exert a magnetic force on the melting element as a current passes through the expulsion element.

3. The interruption device of claim 2 wherein the magnetic force exerted on the melting element by the at least one expulsion element is sufficient to push a melted, vaporized or plasma portion of the melting element away from the printed wiring board surface.

4. The interruption device of claim 3 wherein the at least one expulsion element is electrically connected to the at least one melting element such that a current passing through the at least one melting element also passes through the at least one expulsion element.

5. The interruption device of claim 4 wherein the at least one melting element and the at least one expulsion element lie on or are immediately adjacent the same surface of the printed wiring board.

6. The interruption device of claim 5 wherein the at least one melting element and the at least one expulsion element are generally parallel to one another.

7. The interruption device of claim 5 wherein the at least one melting element lies generally between and perpendicular to a first and a second of the at least one expulsion element.

8. The interruption device of claim 3 wherein the at least one melting element and the at least one expulsion element lie on or are immediately adjacent opposite surfaces of the printed wiring board.

9. The interruption device of claim 8 wherein the electrical connection between the at least one melting element and the at least one expulsion element is contained in a passage through the printed wiring board.

10. The interruption device of claim 3 wherein the at least one expulsion element defines a closed path.

11. The interruption device of claim 10 wherein the at least one expulsion element is inductively coupled to the melting element such that a current flowing through the melting element induces a voltage into the closed path resulting in a current flowing in the closed path.

12. The interruption device of claim 11 wherein the closed path includes at least one attraction conductor and at least one expulsion conductor.

13. The interruption device of claim 3 wherein the at least one melting element is arranged spatially between and generally perpendicular to a first and a second expulsion conductor of the at least one expulsion element such that the at least one melting element passes over an edge of the printed wiring board and the first and second expulsion conductors of the at least one expulsion element lie on or are immediately adjacent opposite surfaces of the printed wiring board.

14. The interruption device of claim 13 wherein the at least one melting element is arranged spatially between and generally perpendicular to a first and a second expulsion conductor of the at least one expulsion element such that the at least one melting element is maintained in a passage through the printed wiring board and the first and second expulsion conductors of the at least one expulsion element lie on or are immediately adjacent opposite surfaces of the printed wiring board.

15. An improved circuit interruption device for printed wiring boards or similar constructions comprising alternating layers of electrical conductors and dielectric material, the interruption device comprising:
at least one melting element, and;
at least one expulsion element, being arranged such that each of the at least one melting element and at least one expulsion element lie on or are immediately adjacent a surface or edge of the printed wiring board or similar construction and are arranged spatially with respect to one another such that a magnetic field surrounding the at least one expulsion element exerts a force on the at least one melting element sufficient to force molten, vaporized or plasma material of the at least one melting element away from that surface or edge of the printed wiring board to which it lies on or is immediately adjacent.

16. An improved circuit interruption device for protecting an electrical circuit at least partially located on a printed wiring board or similar construction comprising alternating layers of electrical conductors and dielectric materials, the interruption device comprising:
at least one melting element, liquefying at a predetermined thermal point caused by an over current condition in the protected electrical circuit, and;
at least one expulsion element, being arranged such that each of the at least one melting element and at least one expulsion element lie on or are immediately adjacent a surface or edge of the printed wiring board or similar construction and are arranged spatially with respect to one another such that a magnetic field surrounding the at least one expulsion element exerts an expulsion force on the at least one melting element sufficient to force liquefied, vaporized or plasma material of the at least one melting element away from that surface or edge of the printed wiring board to which it lies on or is immediately adjacent.

17. The interruption device of claim 16, wherein the similar construction comprising alternating layers of electrical conductors and dielectric materials is a flexible printed wiring board.

18. The interruption device of claim 16, wherein the similar construction comprising alternating layers of electrical conductors and dielectric materials is a flexible flat cable.
